(19) United States
(12) Patent Application Publication
(10) Pub. No.: US 2008/0065616 A1
(43) Pub. Date: Mar. 13, 2008

(54) Metadata integration tool, systems and methods for managing enterprise metadata for the runtime environment

(76) Inventor: Abby H. Brown, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/531,643

(22) Filed: Sep. 13, 2006

(51) Int. Cl. G06F 17/30

(52) U.S. Cl. 707/4

(57) ABSTRACT

A metadata integration tool identifies database communications in a network runtime environment and forwards information about identified database communications to a data store. Although the data is accessed from disparate programs and database technologies, the linkage between programs and data is stored in a centralized data store. The information documents the relationships between the applications that generated the database calls and the target database. This information further identifies and codifies the data abstractions within the target database that were the subject of the communication. This information is then transmitted to and stored in a data store within a data repository. The stored information in the data repository is analyzed in a non-production environment to identify and track database query patterns; data mine for candidates for software reuse, application dependencies, as well as attribute and service notices.

### BACKGROUND

Databases are computerized information storage and retrieval systems. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, a database management system (DBMS) can be structured to support a variety of different types of operations for a requesting entity (e.g., an application, the operating system or an end user). Such operations can be configured to retrieve, add, modify and delete information being stored and managed by the DBMS. Standard database access methods support these operations using high-level query languages, such as the structured query language (SQL). The term “query” denominates a set of commands that cause execution of operations for processing data from a stored database. For instance, SQL supports four types of query operations, i.e., SELECT, INSERT, UPDATE and DELETE. A SELECT operation retrieves data from a database, an INSERT operation adds new data to a database, an UPDATE operation modifies data in a database and a DELETE operation removes data from a database.

A typical enterprise information system (EIS) is comprised of mainframe computers, client computers, middleware servers, and database servers. Internet or Web servers are included within the EIS when Web browser based clients must be served via the Internet/Intranet. EISs are generally known and may include application programs that perform the functions required by any given business and/or organization. For example, an EIS may include, inter alia: online customer order entry systems; online retail/wholesale sales, marketing, and inventory systems; enterprise supply chain management systems; product and/or content distribution systems; online financial systems; service providing systems (including medical, legal, real estate, engineering, education, distance learning, and technical support); online human resource and payroll services; online banking systems (e.g., deployed by a bank or other financial institutions and/or the retail banking systems used internally by bank personnel); reservation systems; and any other general way of transacting business over a network. In addition, EISs (also known as expert information systems) may include a host of programs that enable network and information system managers to monitor the enterprise's information resources. Some of these programs present network and system level operating parameters and real-time data in one or more graphical representations.

EIS application programs often comprise many different application types operating in different environments that need to interact with one or more disparate DBMSs. As a result, enterprise managers are faced with the difficult task of collecting and managing information that can be used to identify risks, allocate resources, determine impacts, integrate and test new applications, and coordinating changes to current applications and databases. Enterprise managers functioning with incomplete, inaccurate or no information at all are exposing the underlying business to a significant risk of downtime and system outages, including outages at retail locations that impact present sales and can alienate customers. These problems are further exacerbated by Web applications and dynamic SQL, which generate code on-the-fly (programmatically) that accesses and manipulates information stored in enterprise databases.

Presently, changes to enterprise environments are managed by distributing announcements and/or requests and waiting for responses from those responsible for impacted applications. This method is time consuming, untimely and error prone. An untimely response or no response at all is often misinterpreted as no impact. Consequently, some enterprise managers expend significant resources in efforts to manage enterprise environments. These efforts include attempts to collect and analyze static information regarding compatibility, data use, data dependency, etc. Static or compiled knowledge of compatibility, data use, and data dependency overlooks what is occurring across the enterprise in its running applications.

Run time describes the operation of a computer program while the program is executing. A runtime environment is a virtual machine state, which provides services for processes or programs while a computer is operating. A runtime environment for an isolated (i.e., non-network coupled) computing device includes the operating system, memory content, programs or processes, and libraries that are operating on the computing device. A runtime environment for network-coupled computing devices further includes distributed libraries and network communications. The runtime environment is where the desired operation of an application program or a suite of application programs is proven or disproved as some program debugging can only be performed at runtime. Timing, network, logic and array bound errors are examples of problems that cannot be discovered during compile-time testing as compile-time testing is not executing the program in a “live” environment with real data. There are libraries and other executables invoked at runtime that cannot be observed in a static snapshot of an application environment.

Thus, improvements in enterprise DBMS administration and methodologies are required to improve business and computing processing efficiencies, specifically in the development of tools, systems and methods that can identify low level runtime relationships between applications and information stored within enterprise databases.

### SUMMARY

A metadata integration tool as well as systems and methods for collecting and managing transient enterprise metadata including dynamically-generated database communications and query pattern analysis in a runtime environment are illustrated and described.

One embodiment of a metadata integration tool includes a filter and a translator. The filter identifies the presence of a predetermined identifier within a dynamically generated database communication in a runtime environment. The translator includes a decoder that identifies metadata responsive to the dynamically generated database communication and an encoder that generates a second communication responsive to the metadata.

An embodiment of a metadata management system includes a controller, a network traffic tool, a central repository and an interface. The controller provides configuration parameters responsive to user inputs to the network traffic tool. The network traffic tool identifies the presence of a predetermined identifier within a dynamically generated database communication from a select source identified via the controller. The network traffic tool generates a second communication responsive to the dynamically generated database communication. The second communication is sent via the network to the central repository. The central repository stores an entry responsive to each received communication from the network traffic tool. The interface forwards business information responsive to one or more entries in the central repository in accordance with an analysis query.

Another embodiment describes a method for managing transient metadata in a runtime environment. The method includes the steps of using a network traffic tool to identify the presence of a predetermined identifier in a dynamically generated database communication in the runtime environment, forwarding a second communication responsive to the dynamically generated database communication to a data repository configured to receive the second communication, storing an entry responsive to the second communication in the data repository and providing an interface configured to communicate business information responsive to the entry in accordance with an analysis query.

Other devices, methods, features and advantages will be or will become apparent to one skilled in the art upon examination of the following figures and detailed description. All such additional devices, methods, features and advantages are defined and protected by the accompanying claims.

### BRIEF DESCRIPTION OF THE DRAWINGS

The present metadata integration tool, systems and methods for managing enterprise metadata, as defined in the claims, can be better understood with reference to the following drawings. The components within the drawings are not necessarily to scale relative to each other; emphasis instead is placed upon clearly illustrating the principles for collecting, storing and analyzing metadata.

FIG. 1 is a functional block diagram illustrating an embodiment of an enterprise network.

FIG. 2 is a functional block diagram illustrating an embodiment of a system for collecting, storing and analyzing metadata that can be integrated within the enterprise network of FIG. 1.

FIG. 3 is a functional block diagram illustrating an embodiment of the network traffic tool of FIGS. 1 and 2.

FIG. 4 is a functional block diagram illustrating an embodiment of the workstation of FIG. 2.

FIG. 5 is flow diagram illustrating an embodiment of a method for managing metadata.

FIG. 6 is a flow diagram illustrating an alternative embodiment of a method for managing metadata.

### DETAILED DESCRIPTION

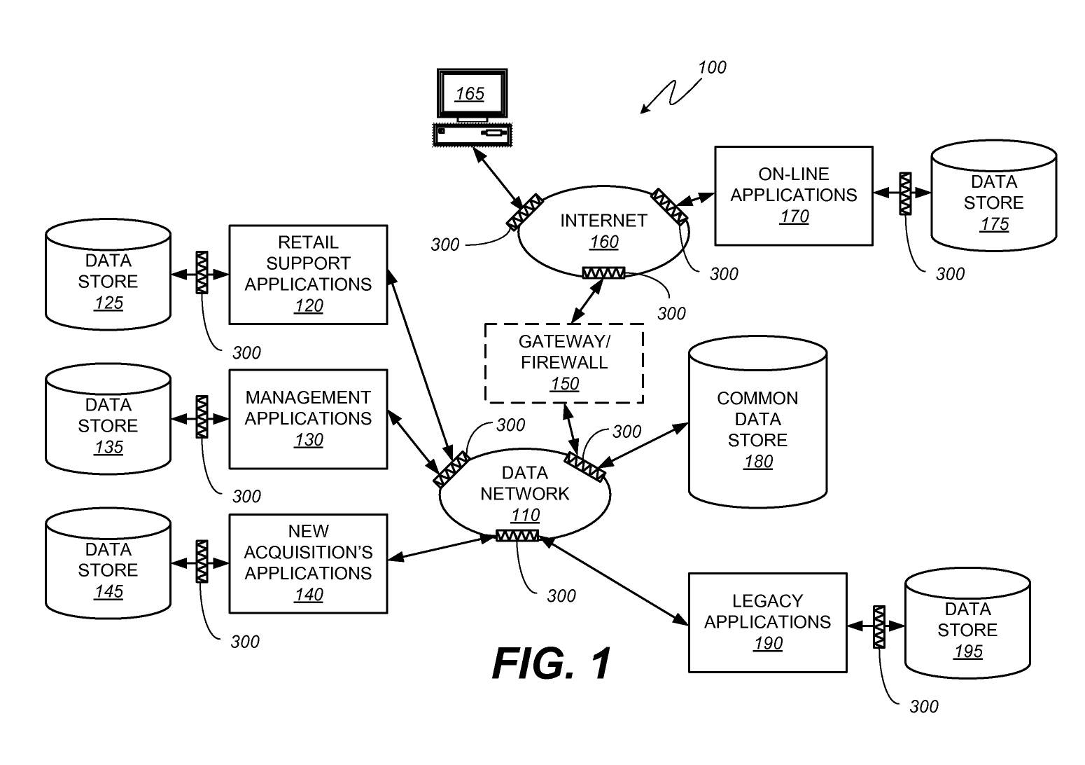

FIG. 1 is a functional block diagram illustrating an embodiment of an enterprise network 100. Enterprise network 100 is a collection of communicatively coupled computers and data storage devices. In the illustrated embodiment, enterprise computing devices are depicted functionally by the various applications that are executed by one or more computing devices. For example, in a functional implementation, one or more computers coupled to data network 110 execute retail support applications. For simplicity of illustration, the one or more computers are depicted as retail support applications 120. In addition, enterprise network 100 includes management applications 130, new acquisition's applications 140, legacy applications 190 and common data store 180 coupled to one another via bi-directional links and data network 110. Common data store 180 is available to support the data storage needs of applications executed across the enterprise network. In addition, each enterprise application is communicatively coupled to a dedicated data store. Retail support applications 120 are coupled to data store 125. Management applications 130 are coupled to data store 135. New acquisition's applications 140 are coupled to data store 145 and legacy applications 190 are coupled to data store 195. Each of data store 125, data store 135, data store 145 and data store 195 include one or more databases or other collections of information dedicated to the support and operation of the respective applications.

Enterprise network 100 also includes Internet 160 which is coupled to data network 110 via optional gateway/firewall 150 and bi-directional communication links. Gateway/firewall 150 selectively allows communications to traverse the bi-directional communication link between Internet 160 and data network 110. Internet 160 supports data transactions between computer 165 and data store 175 via one or more on-line applications 170. Enterprise network 100 includes a number of bi-directional links. It is noted that these enterprise network links may be fixed (i.e., cabled or permanent) or temporary (e.g., modem based or wireless links).

Each of retail support applications 120, management applications 130, new acquisition's applications 140, on-line applications 170 and legacy applications 190 may include inventory and financial applications that operate on disparate operating systems and that interface with disparate DBMSs that store various data abstractions across dedicated data stores (i.e., data store 125, data store 135, data store 145, data store 175 and data store 195) as well as in common data store 180.

As further illustrated in FIG. 1, enterprise network 100 includes a number of strategically placed network traffic tools 300. The network traffic tools 300 may be implemented entirely in software, entirely in hardware or via a combination of software and hardware. Accordingly, the network traffic tools 300 may be implemented in a switch or other network routing device. The network traffic tools 300 are configured to identify select network communications and forward a second communication to a designated storage device coupled to enterprise network 100. Each instance of a network traffic tool 300 is separately controlled to identify network communications that include a predetermined identifier. The predetermined identifier is present in dynamically generated database communications such as requests to select, insert, update and delete data abstractions in a target database. The predetermined identifier can be a single bit flag indicating the presence of additional metadata in a present database communication or a multiple-bit application identifier, the presence of which in a network transmitted data packet triggers the network traffic tool 300 to generate and forward the second communication.

The inserted identifier enables analysis into IP network packets with uniquely engineered bit identifiers. The identifiers serve as unique keys as network traffic may be dynamically routed such that the pattern established by an application may not be discrete. For example, egress and ingress ports between network-coupled hardware devices will vary depending on the routing algorithm used. Under these circumstances, the port id is no longer a reliable means to identify application network traffic.

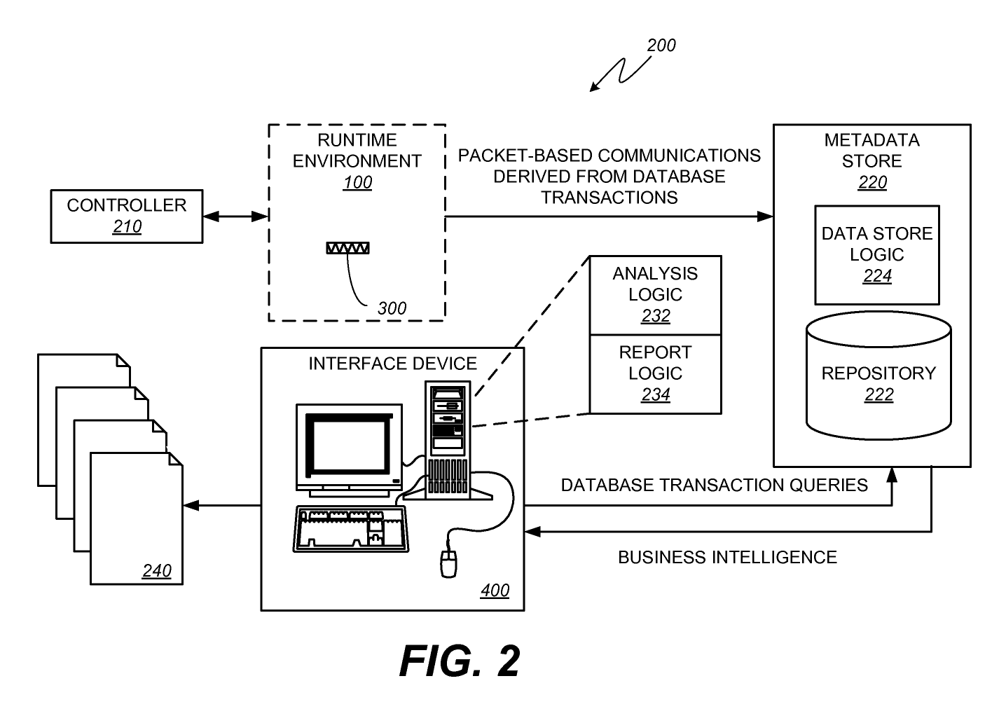

FIG. 2 is a functional block diagram illustrating an embodiment of a system 200 for collecting, storing and analyzing metadata that can be integrated with the enterprise network 100 of FIG. 1. The flow from both mainframe and web based applications will be extracted, translated and loaded into an enterprise (centralized) metadata repository. In its physical sense, this will be a data store within the enterprise data warehouse. Reports and data mining will be resident functions in this data warehouse. System 200 includes controller 210, network traffic tool 300, metadata store 220 and device 400. Network traffic tool 300 is part of enterprise environment 100 (a runtime environment) and is responsive to configuration information provided via controller 210 and network communications. Network communications include extensible markup language (XML) communications transferred via data packets in a packet-switched network architecture.

A runtime environment is an execution environment provided by process managers and other enterprise services on data network 110. The runtime environment defines how executables are loaded into memory, where data is stored, how routines call other routines and system software. The runtime environment includes dynamically generated code such as dynamic structured query logic (SQL) as well as XML-based database communications. Dynamic SQL is code generated programmatically by an application or program before it is executed. Dynamic SQL is used to accomplish tasks based on completed fields on a form or to create tables with varying names. XML is a standard for creating markup languages which describe the structure of data. It is not a fixed set of elements like hypertext markup language (HTML), but rather, it is like standard generalized markup language (SGML) in that it is a meta-language, or a language for describing languages. XML enables authors to define their own tags.

Network traffic tool 300 identifies all applications that insert, select, update and delete data in a database within enterprise network 100. These database transactions or requests include requests generated in the runtime environment from mainframe, distributed and Internet application sources. Network traffic tool 300 generates packet-based communications derived from the identified database transactions. The packet-based communications contain information about each identified database transaction and are designated for delivery to metadata store 220. Data-packets sent to metadata store 220 are processed by data store logic 224, which is configured to extract information from the packet and forward an entry into one or more database request activity logs within repository 222. A local-area network, wide-area network, or dedicated interface between metadata store 220 and device 400 as well as analysis logic 232 and report logic 234 resident on and or accessible to device 400 enable one or more users with access privileges to observe the activity logs and analyze and report the data therein to interested users. Metadata analysis includes analysis queries performed against the information in repository 222.

The use of dynamic SQL has made it traditionally difficult to capture runtime generated database queries because they exist entirely within runtime. That is, the database query is generated and executed in real time at runtime. Across the industry, there has been no centralized method to consolidate the required steps to identify, capture, read and document the source applications responsible for runtime database queries. Dynamic network routing prevents application or source identification at the fixed port level. In this case, even when deep network sniffing techniques are employed, the application identifier cannot be reliably traced back to the originating port. Network traffic tool 300 provides a mechanism to capture this data, understand the implications and apply the knowledge to a predictive and analytical systems environment. The result is significant cost savings associated with actionable steps.

As indicated in FIG. 2, device 400 forwards database transaction queries to metadata store 220 and in return, metadata store 220 returns business intelligence. Business intelligence includes relationships between the processes and applications responsible for the recorded database transactions as well as information about the structure of the target database(s). Business intelligence further includes the source to target linkage of dynamically generated database communications among other information. Analysis logic 232 resident within or accessible by device 400 examines the metadata stored in each of the log entries to collect information regarding database, table and schema or attribute level impacts. Report logic 234 resident within or accessible by device 400 is configured to generate reports 240 that can be communicated in hard copy or electronically to interested enterprise managers, systems analysts, database managers, programmers and others interested in the information.

Although interface device 400 is shown as a workstation, interface device 400 can take the form of any device that can communicate a query, as well as receive and present information. Accordingly, interface device 400 can be a mobile communication device, a laptop computer, or a computing device in other form factors coupled with input/output devices.

Metadata store 220 provides a single location for interested application developers, as well as database, network and enterprise managers to obtain a view of database usage across diverse systems and environments. Because metadata store 220 includes information generated and transmitted in real time, namely an application identifier and target database and description of a data abstraction of interest (e.g., an object, a table, a select data item, etc.), the metadata store 220 enables interested parties to observe at least these parameters from the enterprise runtime environment. Information stored in metadata store 220 is persistent, i.e., it is no longer transient. Metadata store 220 can be accessed and the information stored therein analyzed to identify or otherwise observe database usage/consumption patterns as well as database query patterns generated in the runtime environment.

While metadata store 220 is described as a single storage location, it should be understood that the information stored therein may be distributed or copied across multiple physical storage devices coupled to enterprise network 100.

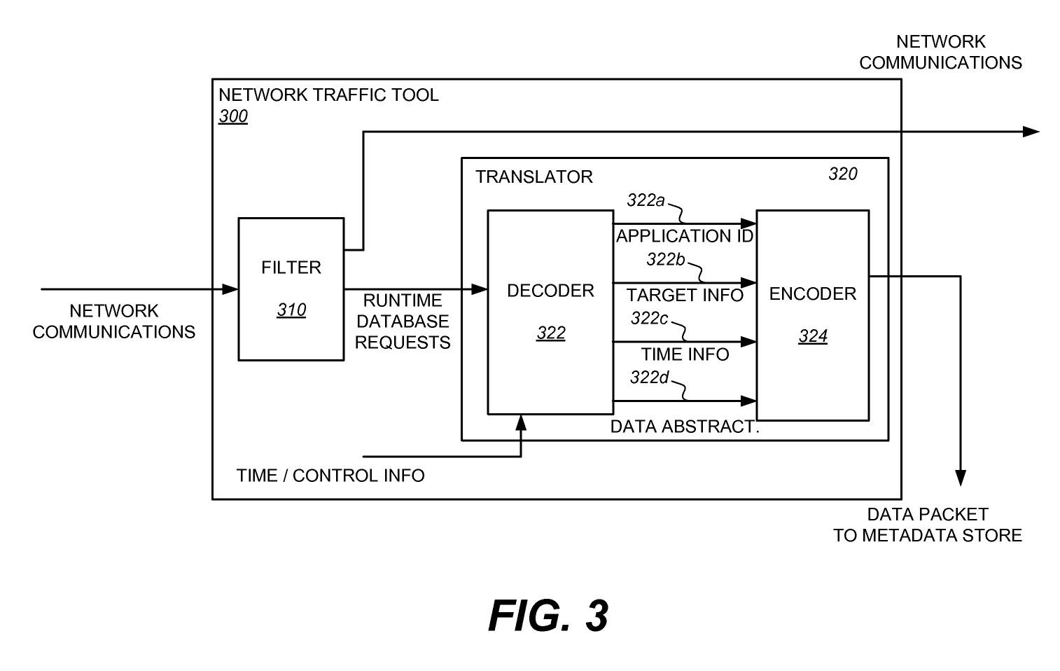

FIG. 3 is a functional block diagram illustrating an embodiment of the network traffic tool 300 of FIGS. 1 and 2. Network traffic tool 300 receives network communications and depending on information therein, either forwards the network communications unchanged to their intended destination or if the network communication is intended for a database, the network traffic tool generates a packet-based communication destined for repository 222 in metadata store 220.

As illustrated in FIG. 3, network traffic tool 300 includes filter 310 and translator 320. Filter 310 receives network communications including control information, dynamically generated database communications and other network traffic. Control information is specific to each instance of network traffic tool 300 and includes parameters that direct filter 310 and translator 320 to respond in a desired manner based on information in a received network communication. In this regard, network traffic tool 300 is controllably responsive to both the source of the network communication and the target database identified in the network communication. Translator 320 includes decoder 322 and encoder 324. Decoder 322 receives control information, dynamically generated database communications or communications and time information. Decoder 322 parses information from the received network communication or otherwise derives or determines an identifier, target database information, and time-related information from the received information. In addition, decoder 322 identifies a source to target linkage of dynamically generated database communications.

The application identifier identifies the application responsible for initiating the network-based database communication. As described above, filter 310 reacts to the presence of predetermined identifier present in the network communication. The predetermined identifier can be one or more bits indicative of a particular location, which directs the filter 310 to forward a copy of the data packet to decoder 322, a pattern of zero or non-zero data levels over a particular range of bits, which both direct the filter 310 to forward a copy of the data packet to decoder 322 and provide directly or indirectly one or more of an application identifier 323a, a target database identifier 323b, and a data abstraction 323d to encoder 324.

Data abstraction 323d may include database specific information such as tables, records, objects, etc. Data abstraction 323d may also include information responsive to the database query. By way of example, data abstraction 323d may include one or more indicators that identify the database query as one of an on-line query from an on-line application, an intermediate query resulting from a nested query, union queries, queries that reference a form value, etc. A SQL nested query is a SELECT query that is nested inside a SELECT, UPDATE, INSERT or DELETE SQL query. A union query combines the result sets of two or more SELECT queries. The union query removes duplicate information (e.g., rows) between the various SELECT statements. Each SQL statement within the union query will have the same number of fields in the result set with similar data types. Queries that reference a form value concatenate references or dependencies that identify additional information.

Encoder 324 receives the application identifier as well as the time and target information and generates a data packet designated for transmission across data network 110 to metadata store 220. More specifically, encoder 324 encapsulates and forwards the received application identifier 323a, target database identifier 323b, available timing information 323c, and data abstraction 323d in an XML format message to metadata store 220. The generated XML format message may use the simple object access protocol (SOAP) to convey information. Data abstractions within a target database includes additional information describing one or more tables, attributes, data items, classes, sub-classes, etc. Time related information may be a network counter or a network distributed representation of relative time. Time information may be used to derive further information regarding database use and consumption patterns including the frequency of various operations with a particular target database.

Network traffic tool 300 enables packet analysis of an altered data packet (i.e., a data packet that includes an abstraction of an application identifier at the bit level). Queries of network traffic tool generated messages are read over the network. In contrast, conventional DBMS analysis includes the analysis of database application specific log files. Network-based storage of network traffic tool 300 generated messages provides a valuable resource for those interested in information that can be determined from dynamic SQL calls. This information can be used to identify and resolve issues with application security, design, data sourcing and understanding the runtime operation of enterprise applications.

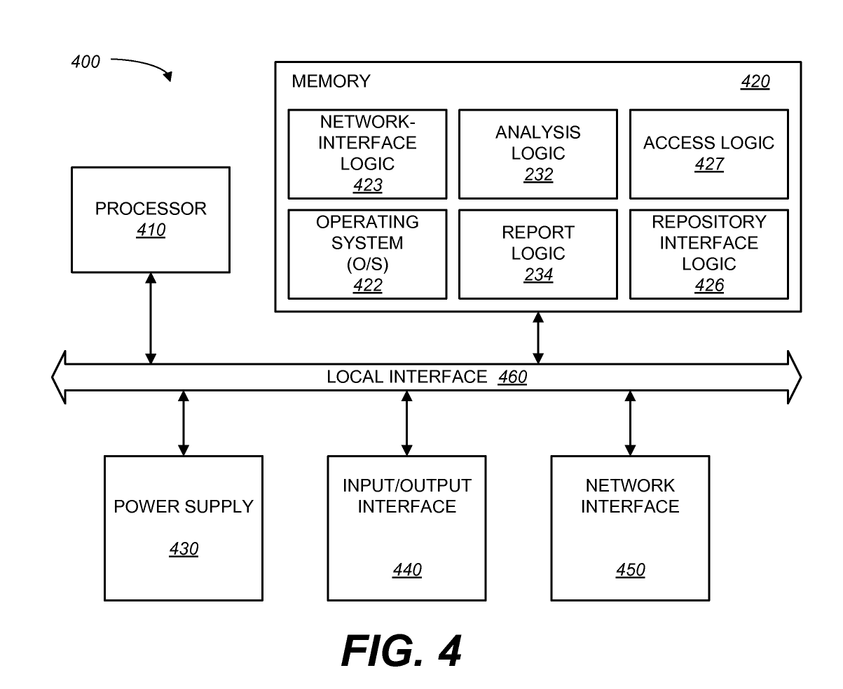

FIG. 4 is a functional block diagram illustrating an embodiment of the interface device of FIG. 2. Generally, in terms of hardware architecture, as shown in FIG. 4, interface device 400 includes processor 410, memory 420, power supply 430, input/output (I/O) interface 440 and network interface 450. Processor 410, memory 420, power supply 430, I/O interface 440 and network interface 450 are communicatively coupled via local interface 460. The local interface 460 can be, for example but not limited to, one or more buses or other wired or wireless connections, as is known in the art. The local interface 460 may have additional elements, which are omitted for simplicity, such as controllers, buffers (caches), drivers, repeaters, and receivers, to enable communications. Further, the local interface 460 may include address, control, power and/or data connections to enable appropriate communications among the aforementioned components.

Power supply 430 provides power to each of the processor 410, memory 420, I/O interface 440, network interface 450 and local interface 460 in a manner understood by one of ordinary skill in the art.

Processor 410 is a hardware device for executing software, particularly that stored in memory 420. The processor 410 can be any custom made or commercially available processor, a central processing unit (CPU), an auxiliary processor among several processors associated with interface device 400, a semiconductor based microprocessor (in the form of a microchip or chip set), or generally any device for executing software instructions.

The memory 420 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, the memory 420 may incorporate electronic, magnetic, optical, and/or other types of storage media. Note that the memory 420 can have a distributed architecture, where various components are situated remote from one another, but can be accessed by the processor 410.

The software in memory 420 may include one or more separate programs, each of which comprises an ordered listing of executable instructions for implementing logical functions. In the example embodiment illustrated in FIG. 4, the software in the memory 420 includes operating system 422, network-interface logic 423, analysis logic 232, report logic 234, repository interface logic 426 and access logic 427. The operating system 422 essentially controls the execution of other computer programs and provides scheduling, input-output control, file and data management, memory management, communication control and related services.

Network-interface logic 423 comprises one or more programs and one or more data elements that enable interface device 400 to communicate with external devices via network interface 450. In this regard, network-interface logic 423 may include one or buffers and parameter stores for holding configuration information and or data as may be required.

Analysis logic 232 includes one or more programs and one or more data elements that enable interface device 400 to examine methodically data entries stored in repository 222. Analysis logic 232 may include one or buffers and parameter stores for holding configuration information and or data as may be required. Analysis logic 232 is configured to examine data entries in aggregate to determine query patterns as well as relationships between applications and target databases that they communicate with in runtime environments. For example, analysis logic 232 searches for relationships between applications and databases to establish impact or dependency tables. Analysis logic 232 searches for relationships between internal database information (e.g., tables, attributes, classes or sub-classes) to identify what applications will need to be updated when a change is made to a specific database structure. Analysis logic 232 includes data mining logic configured to identify usage patterns including non-use of multiple data abstractions within an identified database. Usage information may also include a record of raw data storage consumption.

Report logic 234 includes one or more programs and one or more data elements that enable interface device 400 to generate, store and communicate data from repository 222 as identified by analysis logic 232. Report logic 234 may include one or buffers and parameter stores for holding configuration information and or data as may be required to interface with any number of printers and display devices that may be coupled to interface device 400 via data network 110 or other networks. Report logic 234 may further include an interface to receive ad hoc queries such as which applications access table X in database Y. Report logic 234 is configured to provide data results to one or more output devices such as displays and printers.

Repository interface logic 426 includes one or more programs and one or more data elements that enable interface device 400 to read, write, delete or otherwise maintain the entry logs stored within repository 222. Repository interface logic 426 functions in conjunction with access logic 427 to expose only those features necessary for a particular user. Access logic 427 includes one or more programs and one or more data elements that enable interface device 400 to expose metadata stored in repository 222 to authorized users through interface device 400 or via network coupled devices. Access logic 427 includes one or more identifiers associated with various individuals who should be granted access to the metadata. Those with proper access authority may be authenticated via a user entered password or other mechanisms for identifying a particular user coupled to data network 110 or interacting with repository 222 via interface device 400. Access logic 427 may hold username-password relationships and or other data to authenticate users with access privileges to view or otherwise interact with data in repository 222.

Network-interface logic 423, analysis logic 232, report logic 234, repository interface logic 426 and access logic 427 are source programs, executable programs (object code), scripts, or other entities that include a set of instructions to be performed. When implemented as source programs, the programs are translated via a compiler, assembler, interpreter, or the like, which may or may not be included within memory 420, to operate properly in connection with O/S 422.

I/O interface 440 includes multiple mechanisms configured to transmit and receive information via interface device 400. These mechanisms support human-to-machine and machine-to-human information transfers. Such human-to-machine interfaces may include touch sensitive displays or the combination of a graphical-user interface and a controllable pointing device such as a mouse.

Network interface 450 enables interface device 400 to communicate with various network devices, including metadata store 220 (FIG. 2). Network interface 450 performs a variety of functions including, for example the signal conditioning and format conversions to communicate data through data network 110. Preferably, network interface 450 is compatible with one or both of the Gigabit Ethernet standards (i.e., IEEE 802.3z Fiber Optic Gigabit Ethernet and IEEE 802.3ab Twisted-Pair Gigabit Ethernet) and the TCP/IP protocol. It should be understood that other data-network interfaces compatible with other network protocols including wireless protocols may also be used.

When interface device 400 is in operation, the processor 410 is configured to execute software stored within the memory 420, to communicate data to and from the memory 420, and to control operations of the interface device 400 pursuant to the software. The network-interface logic 423, analysis logic 232, report logic 234, repository interface logic 426, access logic 427 and the O/S 422, in whole or in part, but typically the latter, are read by the processor 410, perhaps buffered within the processor 410, and then executed.

When network-interface logic 423, analysis logic 232, report logic 234, repository interface logic 426 and access logic 427 are implemented in software, as is shown in FIG. 4, it should be noted that these software elements can be stored on any computer-readable medium for use by or in connection with any computer related system or method. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a RAM (electronic), a ROM (electronic), an erasable programmable read-only memory (EPROM), an electrically erasable programmable read-only memory (EEPROM), or Flash memory) (electronic), an optical fiber (optical), and a CDROM (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

In an alternative embodiment, where one or more of the network-interface logic 423, analysis logic 232, report logic 234, repository interface logic 426 and access logic 427 are implemented in hardware, the network-interface logic 423, analysis logic 232, report logic 234, repository interface logic 426 and access logic 427 can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field-programmable gate array (FPGA), etc.

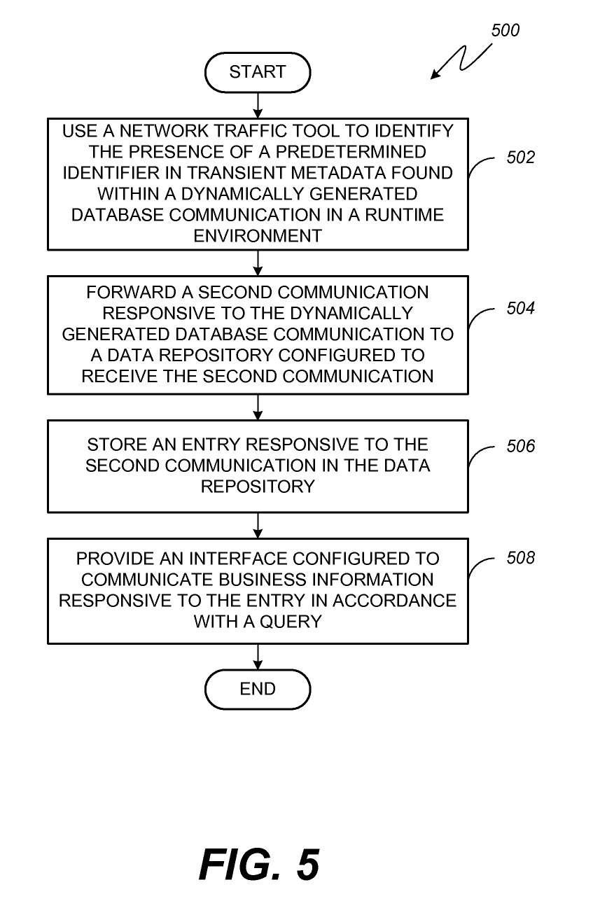

FIG. 5 is flow diagram illustrating an embodiment of a method 500 for managing metadata. The flow diagram of FIG. 5 shows the architecture, functionality, and operation of a possible implementation via software and or firmware associated with communicatively coupled network traffic tools 300 and a data repository 222. In this regard, each block represents a module, segment, or portion of code, which comprises one or more executable instructions for implementing the specified function(s).

Method 500 begins with block 502 where a network traffic tool is used to identify the presence of a predetermined identifier in a dynamically generated database communication in a runtime environment. As indicated in block 504, a second communication responsive to the dynamically generated database communication is created and forwarded to a data repository configured to receive the second communication. As described above, the network traffic tool filters network data traffic. Data traffic that is not designated for a database in the enterprise passes through the filter on its way to the designated destination. Data traffic that includes a database request including a dynamically generated database communication is processed by the network traffic tool. As indicated in block 506, an entry responsive to the second communication is stored in the data repository. In block 508, an interface configured to communicate business information responsive to the entry and a query is provided.

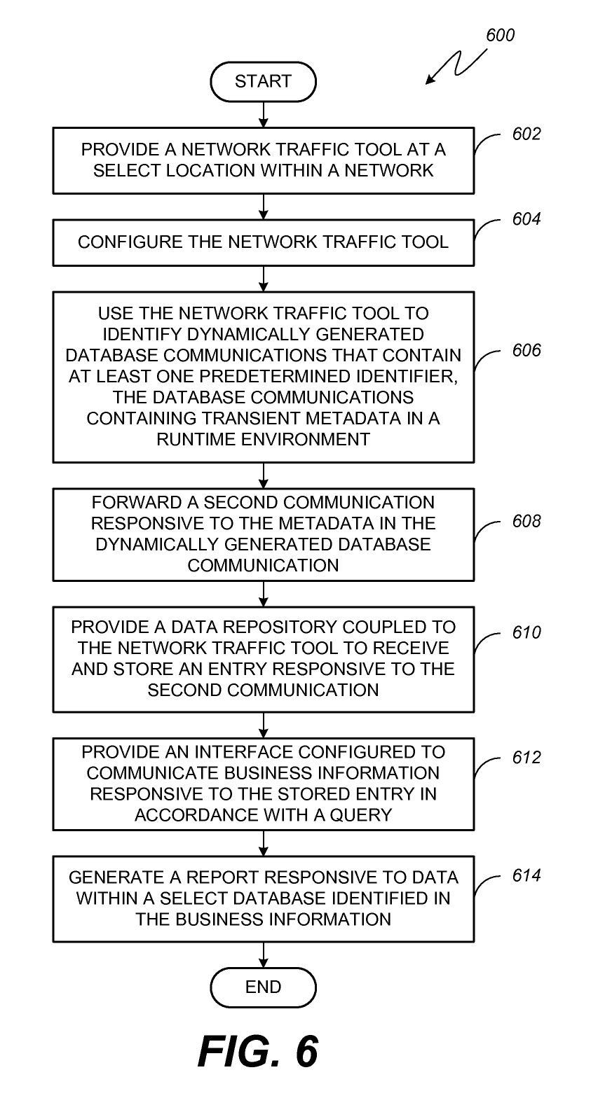

FIG. 6 is a flow diagram illustrating an alternative embodiment of a method 600 for managing metadata. The flow diagram of FIG. 6 shows the architecture, functionality, and operation of a possible implementation via software and or firmware associated with communicatively coupled devices that enable an enterprise wide database management system to collect, store and analyze metadata in a runtime environment. In this regard, each block represents a module, segment, or portion of code, which comprises one or more executable instructions for implementing the specified function(s).

Method 600 begins with block 602 where a system integrator provides a network traffic tool at a select location within a network. As indicated in block 604, the system integrator or an enterprise manager configures the network traffic tool. In block 606, an enterprise manager uses the network traffic tool to identify dynamically generated database communications that contain a predetermined identifier. As indicated in block 606, the database communications contain transient metadata or can be used to derive transient metadata in a runtime environment.

As described above, the network traffic tool filters network data traffic. Data traffic that is not designated for a database in the enterprise passes through the filter on its way to the designated destination. Data traffic that includes a dynamically generated database communication is processed by the network traffic tool.

As indicated in block 608, the network traffic tool forwards a second communication responsive to the metadata derived from the dynamically generated database communication. In block 610, an enterprise manager provides a data repository coupled to the network traffic tool to receive and store an entry responsive to the second communication. Thereafter, in block 612, the enterprise manager provides an interface configured to communicate business information responsive to the stored entry (or stored entries) in accordance with a query. In block 614, an interested party generates a report responsive to data within a select database identified in the business information. For example, a computer engineer may be interested in a report that shows what applications will be impacted by a database outage; programmers may want to know what programs will have to be updated when a particular database changes. Database changes might include rules regarding the format of one or more fields in a record, a data type associated with a field, etc. Moreover, still others may be interested in runtime database query patterns.

As described above, the flow diagrams of FIGS. 5 and 6 show the architecture, functionality and operation of an implementation of example methods for managing metadata in a runtime environment. The described functions can be embodied in source code including human-readable statements written in a programming language or machine code that comprises instructions recognizable by a suitable execution system such as a processor in a computer system. The machine code may be converted from the source code, etc. If embodied in hardware, each block may represent a circuit or a number of interconnected circuits to implement the specified logical function(s).

While the flow diagrams of FIGS. 5 and 6 show specific sequences of execution, it will be appreciated that the functions associated with two or more blocks in the illustrated diagrams that are shown occurring in succession may be executed concurrently or with partial concurrence. In addition, any number of counters, state variables, warning semaphores, or messages might be added to the logical flow described herein, for purposes of enhanced utility, accounting, performance measurement, troubleshooting, etc. All such variations are within the scope of the present systems and methods for managing metadata.

The foregoing description has been presented for purposes of illustration and description. It is not intended to be exhaustive or to limit the scope of the claims to the precise forms disclosed. Modifications or variations are possible in light of the above teachings. The embodiments discussed, however, were chosen and described to enable one of ordinary skill to utilize various embodiments of the metadata integration tool, systems and methods for managing enterprise metadata. All such modifications and variations are within the scope of the appended claims when interpreted in accordance with the breadth to which they are fairly and legally entitled.

What is claimed is:

1. A method for managing transient metadata including dynamically generated network-based communications with disparate databases in a runtime environment, comprising:
a network traffic tool configured to identify the presence of a predetermined identifier in a dynamically generated database communication with a database query in the runtime environment;
forwarding a second communication responsive to the dynamically generated database communication to a data repository configured to receive the second communication;
storing an entry responsive to the second communication in the data repository; and
providing an interface configured to communicate business information responsive to the entry in accordance with an analysis query.

2. The method of claim 1, wherein storing an entry comprises recording at least an application identifier.

3. The method of claim 1, wherein storing an entry comprises recording indicia of both source and target of the dynamically generated database communication.

4. The method of claim 1, wherein storing an entry comprises recording a time associated with the dynamically generated database communication.

5. The method of claim 1, wherein using the network traffic tool comprises determining when the dynamically generated database communication results from runtime generated dynamic structured query logic.

6. The method of claim 1, wherein using the network traffic tool to identify the presence of at least a predetermined identifier comprises determining when the dynamically generated database communication results from an interactive Internet session.

7. The method of claim 1, wherein using the network traffic tool comprises determining when the dynamically generated database communication results from a select source selected from a set of disparate sources.

8. The method of claim 1, wherein using the network traffic tool comprises integrating logic in a network routing device.

9. The method of claim 1, wherein providing an interface comprises using a data extractor responsive to an operator input to identify database consumption/usage patterns.

10. The method of claim 1, wherein providing an interface comprises using analysis logic to generate a report responsive to a data set in an identified database.

11. The method of claim 1, wherein providing an interface comprises using analysis logic to generate a report responsive to a class in an identified database.

12. A metadata integration tool, comprising:
a filter configured to identify the presence of a predetermined identifier in a dynamically generated database communication in a runtime environment; and
a translator coupled to the filter, the translator comprising:
a decoder configured to identify transient metadata within the dynamically generated database communication; and
an encoder coupled to the decoder and configured to generate a second communication responsive to the transient metadata.

13. The tool of claim 12, wherein the filter identifies the dynamically generated database communication from a source selected from the group consisting of an on-line application, an intermediate query resulting from a nested query, union queries, queries that reference a form value, a retail support application, a management application and a new acquisition application.

14. The tool of claim 12, wherein the decoder identifies an application identifier and the source to target linkage of the dynamically generated database communication.

15. The tool of claim 12, wherein the encoder generates a data packet designated for delivery to a network-coupled metadata store.

16. The tool of claim 15, wherein the data packet comprises information in a simple object access protocol.

17. A metadata management system, comprising:
a controller responsive to one or more configuration inputs;
a network traffic tool coupled to the controller and configured to the presence of at least a predetermined identifier in a dynamically generated database communication in the runtime environment, the dynamically generated database communication in a packet designated for delivery to a select target identified by the controller, wherein the network traffic tool generates a second communication responsive to the dynamically generated database communication that identifies an application responsible for generating the dynamically generated database communication;
a repository coupled to the controller and the network traffic tool, the repository configured to receive the second communication and store an entry responsive to the second communication; and
an interface configured to communicate business information responsive to the entry in accordance with an analysis query.

18. The system of claim 17, further comprising:
a device configured with metadata analysis logic configured to identify relationships between the dynamically generated database communication and information within a select database.

19. The system of claim 18, further comprising:
a device configured with report logic configured to arrange identified relationships responsive to entries in the repository.

20. The system of claim 19, wherein report logic generates a report selected from the group consisting of a database impact, an attribute impact, data usage/consumption patterns and database query patterns.
